(19) United States
(12) Patent Application Publication
(10) Pub. No.: US 2011/0130929 A1
(43) Pub. Date: Jun. 2, 2011

(54) SMART ELECTRONIC TRANSMISSION CONTROL SYSTEM

(76) Inventors: Ten-Lee CHANG, Taipei (TW); Tien-Li Chen, Taipei (TW)

(21) Appl. No.: 12/628,854

(22) Filed: Dec. 1, 2009

(51) Int. Cl. G06F 19/00

(52) U.S. Cl. 701/54

(57) ABSTRACT

A smart ETC system is provided. The smart ETC system includes a control circuit electrically connected to a battery, an ignition system, a vehicle speedometer, an ETC device, an automatic transmission, and a brake device. When a vehicle speed detector detects a vehicle speed lower than a predetermined value, the control circuit ignores a present gear, and outputs a neutral gear (N-gear) signal to an automatic transmission to shift the automatic transmission to an N-gear, and then instructs an ignition system of an engine to execute a switch-off instruction. Meanwhile, electric power consumed by all electric appliances is supplied by a battery. When the control circuit detects a signal indicating a battery level lower than a predetermined value, the control circuit outputs an instruction to the ignition system of the engine to restart the engine to charge the battery via a generator.

### BACKGROUND OF THE INVENTION

1. Field of the Invention

The present invention relates generally to a smart idle stop device, for saving idle fuel consumption for long time temporary stop caused by a variety of traffic matters, so as to save fuel cost while caring the driving comfort.

2. The Prior Arts

Recently, the automobile enterprises are fast developed. Driving a car usually help to save the time spent on transportation. However, it also adversely consumes fuel and produces carbon dioxide, which is a main factor causing the green house effect and destroying the quality of the air. Typically, only 30% of fuel burned out by a vehicle engine is used for generating power to drive the vehicle, and almost all of the rest is converted in to heat which is dissipated and emitted out from the heat dissipation system and the flue gas emission system.

Since the petroleum source is going to be finally exhausted, and the earth is becoming warmer and warmer, it is the responsibility of us, particularly those automobile manufacturers who also produce air pollution and noise pollution, to improve the science and technology and driving habit for enhancing the vehicle fuel utilization factor. As reported by the Discovery Channel, the USA alone consumes ¼ of petroleum of the world, and 55% of which is consumed by 230 million vehicles. Roughly estimated in accordance with the report, it can be concluded that almost a half of the petroleum of world is being consumed as fuels of vehicles. The vehicles are seriously relying on the supply of petroleum and are drastically destroying the environment.

Even though almost all of the major automobile manufacturers have made effort to develop next generation cars, such as fuel-electric hybrid vehicles, the conventional gas/diesel engine cars still occupy most part of the car production in the world (about 90%). Therefore, in general, the effect of the effort for saving is not satisfactory as desired.

The reason of the high fuel consumption efficiency of the conventional gas/diesel engine cars may be because the overall design does not include more consideration about fuel saving. FIG. 3 is a schematic diagram illustrating a convention auto-transmission and brake system. As shown in FIG. 3, when the engine 13a is in an idling status, it remains running. The idling status may be maintained for a short time, e.g., several seconds, or up to several minutes, or even longer. In this situation, if the engine is manually turned off, the driver must shift the gear shifter 1 to neutral gear (N-gear) or parking gear (P-gear), and then restart the engine 13a. Such a complicated operation brings inconvenience for driving. Further, for avoiding over consumption of electric power of the battery 15, electric appliances 12 which consume electric power provided by the battery 15 must be turned off at the same time. When the vehicle is driven in a hot weather, the driver and the passenger will feel uncomfortable staying in the vehicle.

### SUMMARY OF THE INVENTION

A primary objective of the present invention is to provide a smart electronic transmission control system adapted for being installed in a vehicle. The smart electronic transmission control system utilizes an automatic control circuit for controlling the idle stop system, so that after idling for a certain time the vehicle can automatically turn off the engine for saving the fuel consumption, and can be conveniently restarted.

According to an embodiment of the present invention, a smart electronic transmission control (ETC) system is provided in a conventional vehicle configuration. The smart ETC system is constituted of a control circuit and a conventional ETC device. In accordance with the smart ETC system, when a vehicle speed detector detects a vehicle speed lower than a predetermined value, the control circuit ignores a present gear, and outputs a neutral gear (N-gear) signal to an automatic transmission to shift the automatic transmission to an N-gear, and then instructs an ignition system of an engine to execute a switch-off instruction. Meanwhile, electric power consumed by all electric appliances is supplied by a battery. When the control circuit detects that a signal indicating a battery level lower than a predetermined value, the control circuit outputs an instruction to the ignition system of the engine to restart the engine to charge the battery via a generator. When the vehicle is going to be driven to move forward, the driver sends a signal to the control circuit by stepping on the brake device, and then the control circuit receives the signal and determines a present status of the engine, and then determines whether or not to output an engine restart signal. After the engine status is confirmed to be restarted, the control circuit instructs the automatic transmission to shift from the N-gear back to the previous gear, and the driver can then drive the vehicle by stepping on the accelerator pedal.

In accordance with the present invention, the smart ETC system includes a control circuit integrated in a vehicle. The control circuit is electrically connected to an ETC device and an automatic transmission, for serving as a control interface communicating between the ETC device and the automatic transmission. When a certain gear is selected by the driver via a transmission gear, a signal corresponding to the selected gear is sent to the control circuit. When the vehicle speed detector detects a vehicle speed higher than a predetermined value, the control circuit outputs a signal consistent to a present gear to the automatic transmission to maintain the vehicle being driven with the present gear. When the vehicle speed detector detects a vehicle speed equal to or lower than the predetermined value, the control circuit outputs a signal corresponding to the neutral gear to the automatic transmission to shift from the present gear to the neutral gear, and then instructs the ignition system of the engine to execute a switch-off instruction so as to achieve an automatic idle stop. The driver does not need to operate to shift the gear, and the electric appliances of the vehicle are provided with power from the battery. If the engine is remained off for too long a time such that the battery level is lower than a predetermined value, the control circuit outputs an instruction to the ignition system of the engine to restart the engine to charge the battery via a generator.

When the vehicle is in an idle stop status, and is going to be again driven to move forward, the driver sends a signal to the control circuit by stepping on the brake device, and then the control circuit receives the signal and determines a present status of the engine, and then determines whether or not to output an engine restart signal. After the engine status is confirmed to be restarted, the control circuit instructs the automatic transmission to shift from the N-gear back to the previous gear, and the driver can then drive the vehicle by stepping on the accelerator pedal.

The present invention further includes an information display unit disposed in front of the driver seat and electrically connected to the control circuit, so as to allow the driver to learn the battery level and/or battery consumption related information.

### BRIEF DESCRIPTION OF THE DRAWINGS

The present invention will be apparent to those skilled in the art by reading the following detailed description of preferred embodiments thereof, with reference to the attached drawings, in which:

FIG. 1 is a schematic diagram illustrating a first embodiment of the present invention;

FIG. 2 is a schematic diagram illustrating a second embodiment of the present invention; and

FIG. 3 is a schematic diagram illustrating a conventional auto-transmission and brake system.

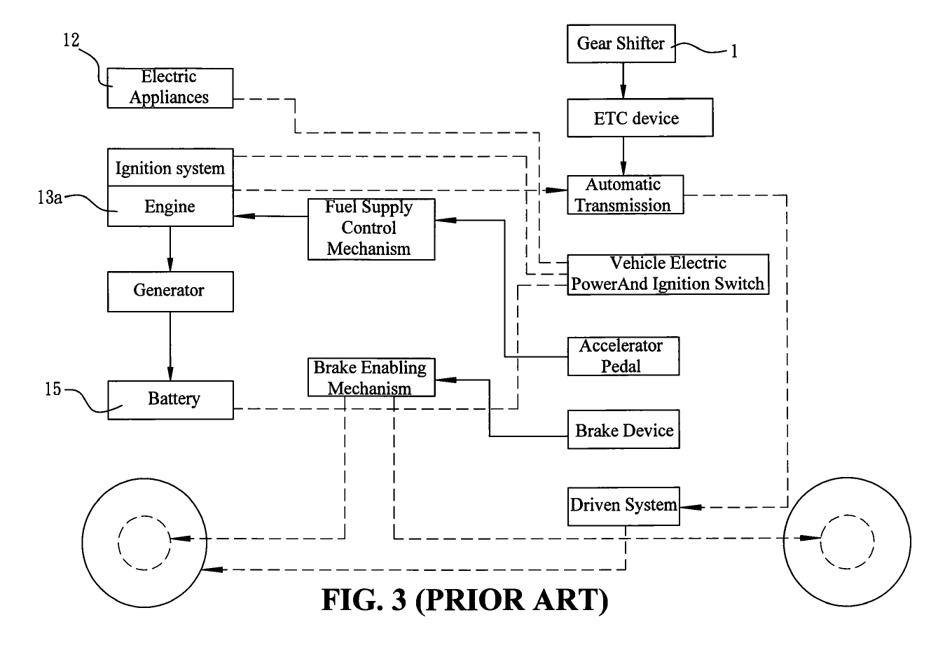

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

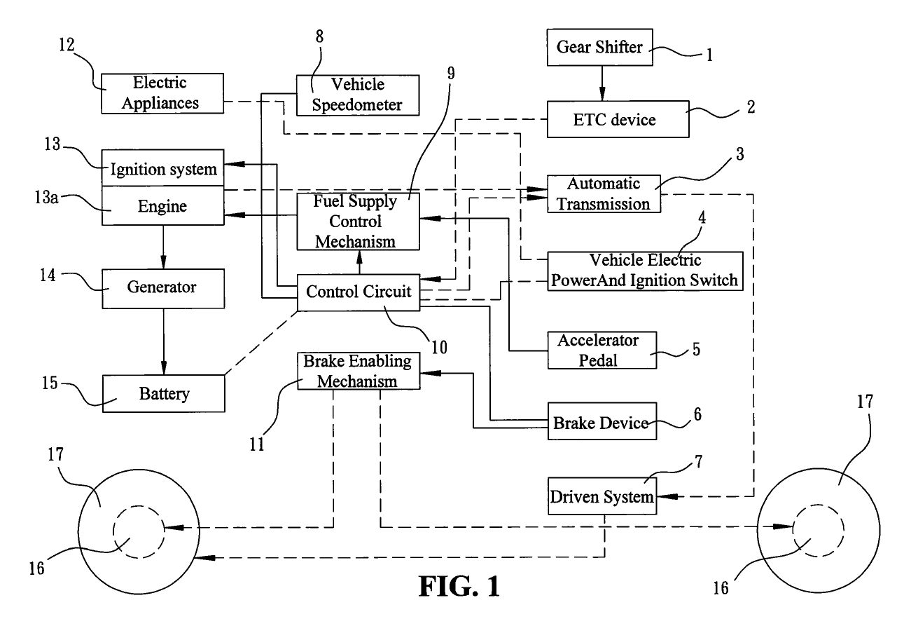

FIG. 1 is a schematic diagram illustrating a first embodiment of the present invention. Referring to FIG. 1, there is shown a smart ETC system of a vehicle. The smart ETC system includes an engine 13a, an ignition system 13 of the engine 13a, a generator 14, a control circuit 10, a vehicle speedometer 8, a battery 15, a fuel supply control mechanism 9, a gear shifter 1, an ETC device 2, an automatic transmission 3, a vehicle electric power and ignition switch 4, an accelerator pedal 5, a brake device 6, and a driven system 7. The control circuit 10 is electrically connected to the battery 15, the vehicle speedometer 8, the ignition system 13, the ETC device 2, the automatic transmission 3, the vehicle electric power and ignition switch 4, and the brake device 6 which is adapted for enabling a brake enabling mechanism 11 for controlling a brake system 16 equipped at wheels 17 of the vehicle. Any signal communication among components foregoing introduced as being electrically connected to the control circuit 10 must be controlled by the control circuit 10. The control circuit 10 includes a vehicle speed detector.

When a driver starts to drive a vehicle installed with the smart ETC system, the gear shifter 1 is firstly shifted to a parking gear (P-gear) or a neutral gear (N-gear). At the same time, a signal indicating the present P-gear or N-gear to the control circuit 10. The control circuit 10 then forwards the signal to the automatic transmission 3. The vehicle electric power and ignition switch 4 is then operated to send a motor start-up and ignition signal to the control circuit 10, and the control circuit 10 correspondingly instructs the ignition system 13 to start up the engine 13a. Therefore, the driven system 7 drives the wheels to rotate, and simultaneously drives the generator 14 to charge the battery 15.

When the driver is driving the vehicle, the gear shifter 1 is presented at a certain gear, and when the driver steps on the brake device 6, the brake enabling mechanism 11 drives the brake system 16 to brake the wheels 17. Meanwhile, the vehicle speed down or stops, so that the vehicle speed detector of the control circuit 10 detects a vehicle speed data transmitted from the vehicle speedometer 8 indicating a vehicle speed equal to or lower than a predetermined value, the control circuit 10 then ignores the present certain gear, and outputs an N-gear signal to the automatic transmission 3 to shift the automatic transmission 3 to an N-gear. The control circuit 10 then instructs the ignition system 13 of the engine 13a to execute a switch-off instruction. Meanwhile, electric power consumed by all electric appliances 12 is supplied by the battery 15. If the engine 13a is remained off for too long a time, the battery capacity becomes insufficient, then the control circuit 10 detects a signal indicating a battery level of the battery 15 lower than a predetermined value, the control circuit 10 outputs an instruction to the ignition system 13 of the engine 13a to restart the engine 13a to charge the battery 15 via a generator 14.

When the vehicle is still and the engine 13a is started up from a cold status, the driver must manually turn on the vehicle electric power and ignition switch 4 to start the ignition system 13 so as to start up the engine 13a. In this time, if it is detected that engine 13a is in an idle operation status for a time longer than a predetermined value, the control circuit 10 executes an idle stop instruction to the ignition system 13.

When the vehicle is in an idle stop status, and is going to be again driven to move forward, the driver sends a signal to the control circuit 10 by stepping on the brake device 6, and then the control circuit 10 receives the signal and determines a present status of the engine 13a, and then determines whether or not to output an engine restart signal. After the engine status is confirmed to be restarted, the control circuit 10 instructs the automatic transmission 3 to shift from the N-gear back to the previous gear, and the driver can then drive the vehicle by stepping on the accelerator pedal 5, so as to drive the fuel supply control mechanism 9 to supply the fuel to the engine 13a.

In particular, according to an aspect of the embodiment, after stepping on the brake device 6, the driver can release the brake device 6 and again steps on the brake device 6 in a predetermined time so as to touch a brake switch to output a signal for changing a brake indication displayed on the instrument panel and the stop lights. When the signal outputted from the brake switch is received by the control circuit 10, it can be accorded for determining to restart the engine 13a. The times of stepping on the brake device 6 can be set by the control circuit. Or alternatively, a sensor can be equipped at a pedal of the brake device 6 for detecting the times of stepping on the brake device 6.

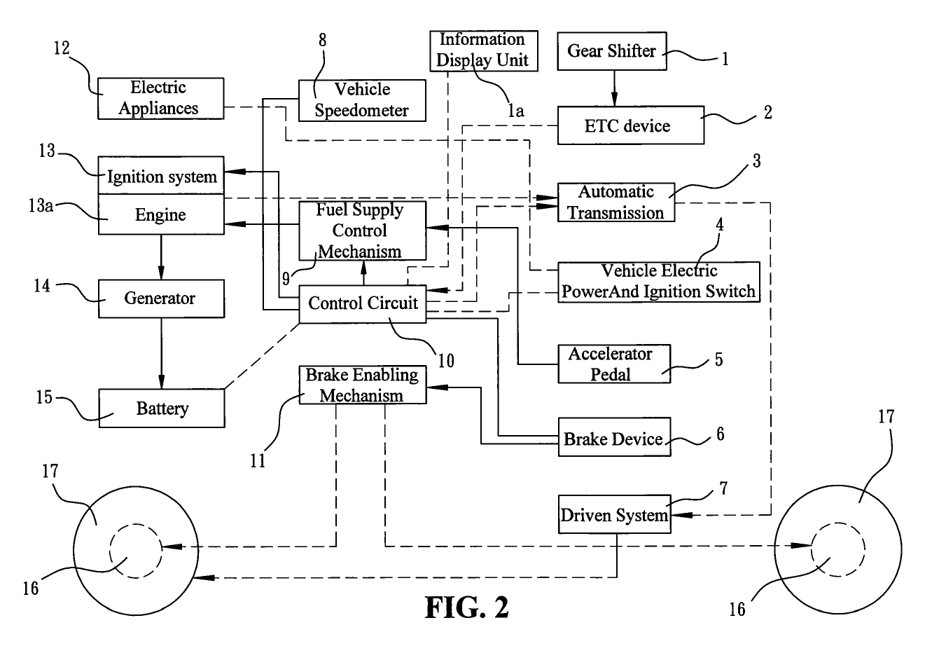

FIG. 2 is a schematic diagram illustrating a second embodiment of the present invention. The second embodiment as shown in FIG. 2 is substantially similar with the first embodiment as shown in FIG. 1, except that the smart ETC system further includes an information display unit 1a disposed in front of the driver seat and electrically connected to the control circuit 10, so as to allow the driver to learn the battery level and/or battery consumption related information.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A smart electronic transmission control (ETC) system of a vehicle, comprising:
an engine, having an ignition system;
a generator;
a battery;
a fuel supply control mechanism;
a gear shifter;
an ETC device;
an automatic transmission;
a vehicle speedometer;
a brake device;
a driven system; and
a control circuit, electrically connected to the ignition system of the engine, the battery, the vehicle speedometer, the ETC device, the automatic transmission, and the brake device,
wherein the control circuit comprises a vehicle speed detector for detecting a signal indicating a vehicle speed, wherein when the signal indicates a vehicle speed lower than a predetermined value, the control circuit ignores a gear signal corresponding to a present gear of the ETC device, and outputs a neutral gear (N-gear) signal to the automatic transmission to shift the automatic transmission to an N-gear, and then instructs the ignition system of the engine to execute a switch-off instruction, and meanwhile, electric power consumed by all electric appliances is supplied by a battery, and when the signal indicates a battery level lower than a predetermined value, the control circuit outputs an instruction to the ignition system of the engine to restart the engine to charge the battery via the generator.

2. The smart ETC system according to claim 1, wherein when the engine is in an idle stop status and needs to be restarted up, an instruction signal is sent to the control circuit by stepping on the brake device, and then the control circuit receives the signal and determines a present status of the engine, wherein the instruction signal is accorded for determining whether or not to output an engine restart signal to restart the engine, after the engine status is confirmed to be restarted, the control circuit instructs the automatic transmission to shift from the N-gear back to the previous gear.

3. The smart ETC system according to claim 1, wherein the control circuit is electrically connected to an information display unit for displaying the battery level and/or battery consumption related information.

4. The smart ETC system according to claim 2, wherein the control circuit is electrically connected to an information display unit for displaying the battery level and/or battery consumption related information.
